(19) United States
(12) Patent Application Publication
(10) Pub. No.: US 2006/0108943 A1
(43) Pub. Date: May 25, 2006

(54) Light source module with a light-emitting diode

(76) Inventor: Wen-Liang Hsia, Kaohsiung City (TW)

Correspondence Address: FROMMER LAWRENCE & HAUG, 745 FIFTH AVENUE- 10TH FL., NEW YORK, NY, 10151, US

(21) Appl. No.: 10/997,184

(22) Filed: Nov. 24, 2004

(51) Int. Cl. H05B 37/00

(52) U.S. Cl. 315/245; 315/312

(57) ABSTRACT

A light source module includes a circuit board and a light source circuit. The light source circuit is mounted on the circuit board, and includes a light-emitting diode, and a pair of second electrical contacts, each of which is coupled to the light-emitting diode. The light source module is to be installed to a ceiling light fixture of an automobile.

### BACKGROUND OF THE INVENTION

1. Field of the Invention

The invention relates to a light source module, more particularly to a light source module that includes a light-emitting diode.

2. Description of the Related Art

A conventional light source for a ceiling light fixture 1 of an automobile (not shown) includes a light bulb 15. The ceiling light fixture 1 includes a light socket 11 provided with a pair of first electrical contacts 13, a transparent shield 12 that serves to cover the light socket 11, and a switch 14 that connects and disconnects selectively the first electrical contacts 13 to and from a power source (not shown). The light bulb 15 has a pair of second electrical contacts, each of which is connected electrically and removably to a respective one of the first electrical contacts 13 on the light socket 11 of the ceiling light fixture 1.

The aforementioned conventional light source is disadvantageous in that the light bulb 15 generates light that lacks in brightness.

With further reference to FIG. 2, to solve this problem, it has been proposed to replace the light bulb 15 with a conventional light source module that includes a fluorescent lamp 25.

Although the fluorescent lamp 25 generates a relatively bright light, due to the inherent size of the fluorescent lamp 25, the ceiling light fixture has to be replaced. This might cause damage to the interior of the automobile.

FIG. 3 illustrates another conventional light source module that includes a circuit board 34, a cold cathode lamp 35, a controller 37, and a pair of second electrical contacts 37. The cold cathode lamp 35 is mounted on the circuit board 34. The controller 37 is mounted on the circuit board 34 and is coupled to the cold cathode lamp 35. Each of the second electrical contacts 37 is mounted on the circuit board 34, is coupled to the cold cathode lamp 35, and is connected electrically and removably to the first electrical contacts 13 on the light socket 11 of the ceiling light fixture 1.

Although the cold cathode lamp 35 generates a relatively bright light, the controller 37 includes a transformer that has a large size.

### SUMMARY OF THE INVENTION

Therefore, the main object of the present invention is to provide a light source module that is capable of overcoming the aforesaid drawbacks of the prior art.

According to the present invention, a light source module comprises a circuit board and a light source circuit. The light source module is adapted to be mounted on a ceiling light fixture of an automobile. The ceiling light fixture includes a light socket provided with a pair of first electrical contacts. The light source circuit is mounted on the circuit board, and includes a light-emitting diode, and a pair of second electrical contacts, each of which is coupled to the light-emitting diode and is adapted to be coupled to a respective one of the first electrical contacts.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view illustrating a conventional light bulb disposed in a ceiling light fixture;

FIG. 2 is a sectional view illustrating a conventional light source module disposed in a ceiling light fixture;

FIG. 3 is a sectional view illustrating another conventional light source module disposed in a ceiling light fixture;

FIG. 4 is a sectional view of the first preferred embodiment of a light source module according to the present invention;

FIG. 5 is a schematic circuit diagram of the first preferred embodiment;

FIG. 6 is a sectional view of the second preferred embodiment of a light source module according to the present invention; and

FIG. 7 is a sectional view of the third preferred embodiment of a light source module according to the present invention.

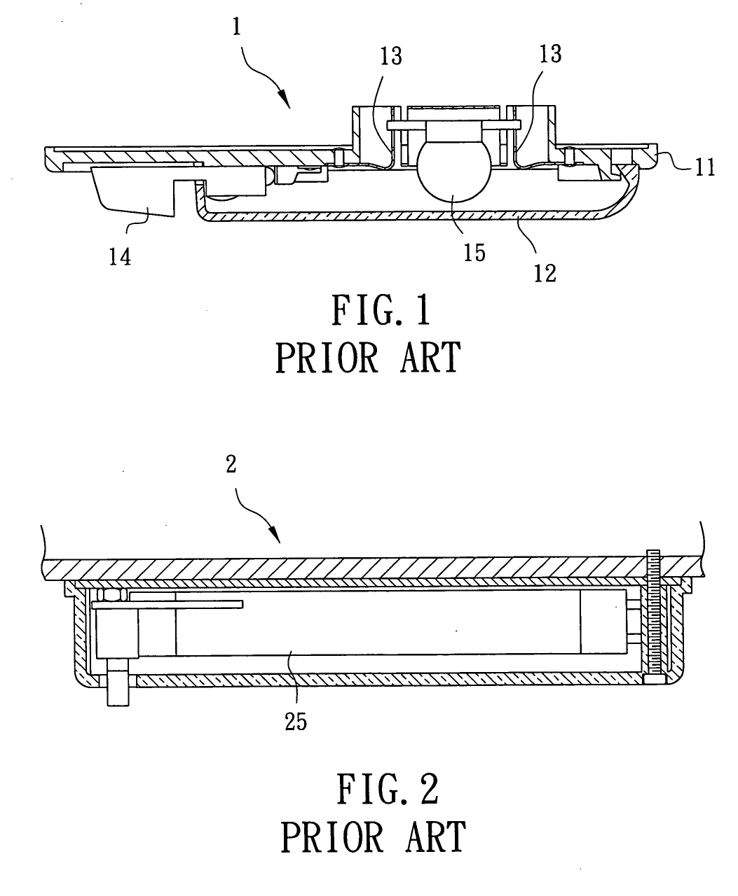

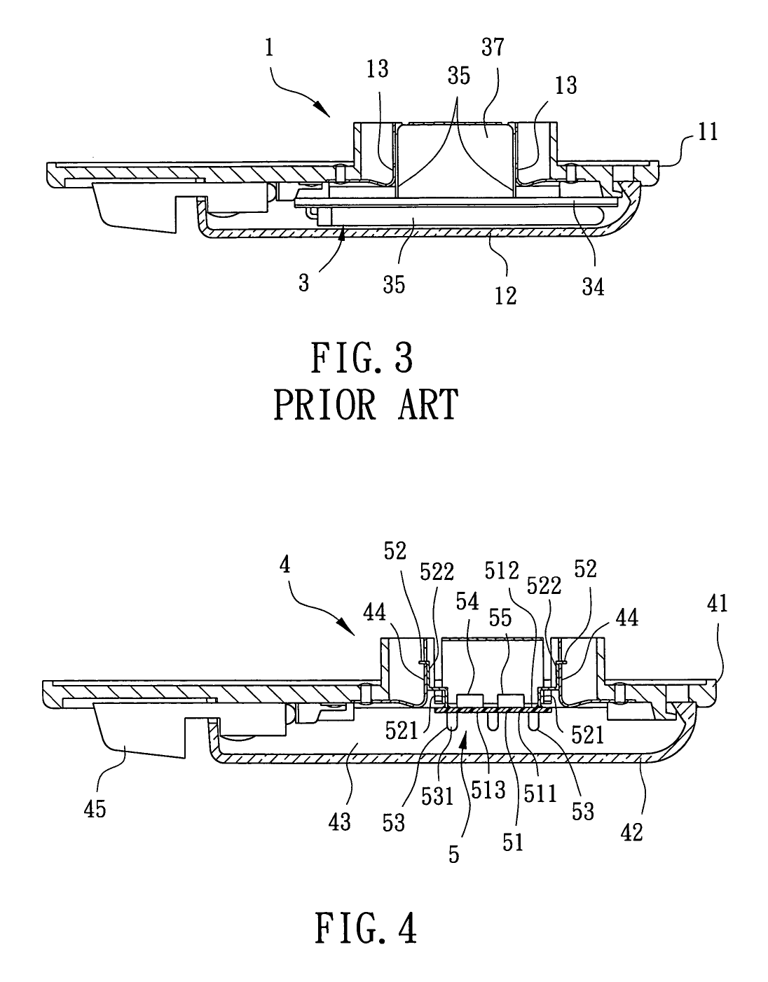

### DETAILED DESCRIPTION OF THE PREFERRED EMBODIMENTS

Before the present invention is described in greater detail, it should be noted that like elements are denoted by the same reference numerals throughout the disclosure.

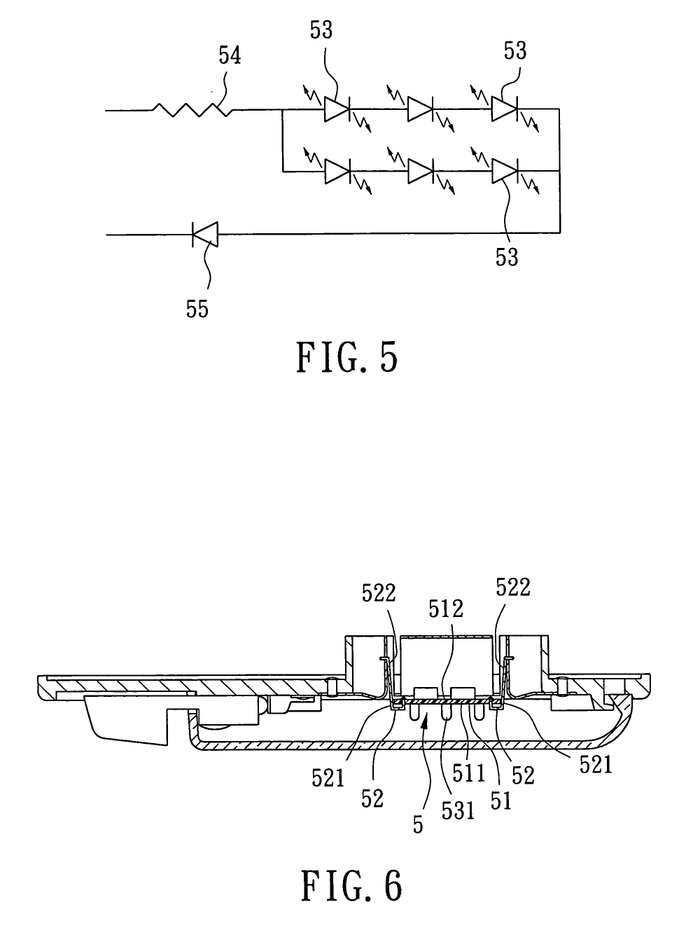

Referring to FIGS. 4 and 5, the first preferred embodiment of a light source module 5 according to this invention is shown to include a circuit board 51 and a light source circuit.

The light source module 5 of this embodiment is mounted on a ceiling light fixture 4 of an automobile (not shown). The ceiling light fixture 4 includes a light socket 41 provided with a pair of first electrical contacts 44, a transparent shield 42 that serves to cover the light socket 41, and a switch 45 that connects and disconnects selectively the first electrical contacts 44 to and from a power source, such as a battery.

The circuit board 51 has opposite first and second surfaces 511, 512, and an edge 513 that extends between the first and second surfaces 511, 512.

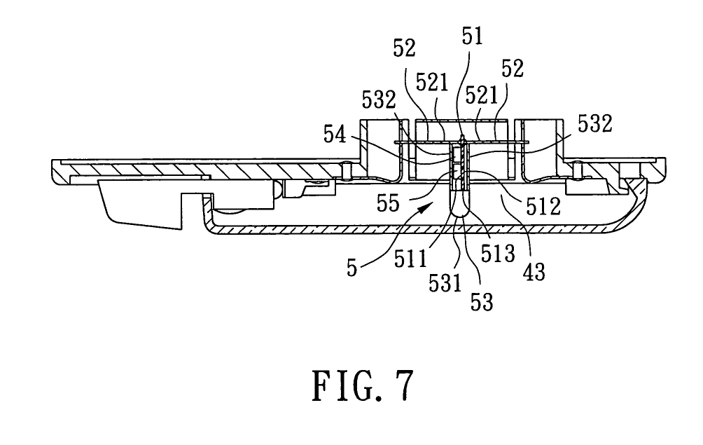

The light source circuit is mounted on the circuit board 51, and includes a pair of second electrical contacts 52 and a plurality of light-emitting diodes 52. As best shown in FIG. 5, the light-emitting diodes 53 are grouped into two sets of light-emitting diodes 53 that are connected in parallel. Each set includes three light-emitting diodes 53. It is noted that each of the light-emitting diodes 53 includes a cap 531, and a pair of diode terminals 532 (see FIG. 7), each of which extends outwardly of the cap 531.

The light source circuit further includes a resistor 54 and a diode 55. The resistor 54 is connected electrically in series between one of the second electrical contacts 52 and the parallel sets of light-emitting diodes 53. The diode 55 is connected electrically in series between the other of the second electrical contacts 52 and the parallel sets of light-emitting diodes 53. It is noted that the diode 55 serves to protect the light-emitting diodes 53 from a reverse-current, such as during reverse-battery connection. In an alternative embodiment, the diode 55 is dispensed with.

In this embodiment, the cap 531 of each of the light-emitting diodes 53 is mounted on the first surface 511 of the circuit board 51. Moreover, the resistor 54 and the diode 55 are mounted on the second surface 512 of the circuit board 51. Further, each of the second electrical contacts 52 is disposed on the second surface 512 of the circuit board 51, and has a first end portion 521 soldered on the second surface 512 of the circuit board 51, and a second end portion 522 connected electrically and removably to a respective one of the first electrical contacts 44.

FIG. 6 illustrates the second preferred embodiment of a light source module 5 according to this invention. When compared to the previous embodiment, the first end portion 521 of each of the second electrical contacts 52 extends through the circuit board 51 and is soldered on the second surface 512 of the circuit board 51.

FIG. 7 illustrates the third preferred embodiment of a light source module 5 according to this invention. When compared to the previous embodiments, the first End portion 521 of each of the second electrical contacts 52 is soldered on a respective one of the first and second surfaces 511, 512 of the circuit board 51. Moreover, the cap 531 of each of the light-emitting diodes 53 is disposed on the edge 513 of the circuit board 51. Further, the diode terminals 532 of each of the light-emitting diodes 53 are respectively disposed adjacent to the first and second surfaces 511, 512 of the circuit board 51, and are respectively soldered to the second electrical contacts 52.

From the above description, the light source module 5 of this invention is relatively easy to install and uninstall to and from the ceiling light fixture 4 of the automobile, provides a relatively brighter light, and has a relatively small size.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light source module for a ceiling light fixture of an automobile, the ceiling light fixture including a light socket provided with a pair of first electrical contacts, said light source module comprising:
a circuit board; and
a light source circuit mounted on said circuit board, and including
a light-emitting diode; and
a pair of second electrical contacts, each of which is coupled to said light-emitting diode and is adapted to be coupled to a respective one of the first electrical contacts.

2. The light source module as claimed in claim 1, wherein said light source circuit further includes a resistor connected electrically in series between one of said second electrical contacts and said light-emitting diode.

3. The light source module as claimed in claim 2, wherein said light source circuit further includes a diode connected electrically in series between the other one of said second electrical contacts and said light-emitting diode.

4. The light source module as claimed in claim 3, wherein said circuit board has opposite first and second surfaces, said light-emitting diode being mounted on said first surface of said circuit board, said resistor and said diode being mounted on said second surface of said circuit board, each of said second electrical contacts being disposed on said second surface of said circuit board, and having a first end portion soldered on said second surface of said circuit board, and a second end portion adapted to be connected electrically to a respective one of the first electrical contacts.

5. The light source module as claimed in claim 3, wherein said circuit board has opposite first and second surfaces, said light-emitting diode being disposed on said first surface of said circuit board, said resistor and said diode being disposed on said second surface of said circuit board, each of said second electrical contacts having a first end portion that extends through said circuit board and that is soldered on said second surface of said circuit board, and a second end portion adapted to be connected electrically to a respective one of the first electrical contacts.

6. The light source unit as claimed in claim 1, wherein said circuit board has opposite first and second surfaces, and an edge that extends between said first and second surfaces,
each of said second electrical contacts having a first end portion that is soldered on a respective one of said first and second surfaces of said circuit board, and a second end portion that is adapted to be connected electrically to a respective one of the first electrical contacts,
said light-emitting diode including a cap, and a pair of diode terminals, each of which extends outwardly of said cap, said cap of said light-emitting diode being disposed on said edge of said circuit board, said diode terminals of said light-emitting diode being respectively disposed adjacent to said first and second surfaces of said circuit board, and being respectively soldered to said second electrical contacts.
